(19) United States
(12) Patent Application Publication
(10) Pub. No.: US 2009/0184929 A1
(43) Pub. Date: Jul. 23, 2009

(54) COMPUTER SYSTEM AND MULTIMEDIA INPUT DEVICE THEREOF

(75) Inventor: Shih-Kun Chou, Taipei (TW)

Correspondence Address: RABIN & Berdo, PC, 1101 14TH STREET, NW, SUITE 500, WASHINGTON, DC, 20005, US

(73) Assignee: ASUSTek COMPUTER INC., Taipei (TW)

(21) Appl. No.: 12/349,238

(22) Filed: Jan. 6, 2009

(30) Foreign Application Priority Data
Jan. 17, 2008 (TW) 97101774

(51) Int. Cl. G09G 5/00

(52) U.S. Cl. 345/172

(57) ABSTRACT

A computer system and a multimedia input device thereof are disclosed. The multimedia input device is used for providing a shortcut input of the computer system. The computer system further includes a computer host and a display device, and it can execute several programs. The multimedia input device includes a body and a plurality of hot keys. The main body is connected to the computer host via wire or wireless. The hot keys are disposed on the body. Each of the hot keys corresponds to one predict program to be executed.

### COMPUTER SYSTEM AND MULTIMEDIA INPUT DEVICE THEREOF

This application claims the benefit of Taiwan application Serial No. 97101774, filed Jan. 17, 2008, the subject matter of which is incorporated herein by reference.

### BACKGROUND OF THE INVENTION

1. Field of the Invention

The invention relates to an input device and, more particularly, to a computer system and a multimedia input device thereof.

2. Description of the Related Art

With the development of the computer science and technology, the computer peripherals such as keyboards, mice, loudspeakers, webcams, or microphones with earphones have more functions for users to choose to facilitate the users' operation. In addition, the computer peripherals allow the interaction between computers and the users to be more direct and humanized.

For example, a webcam can capture the position of a dynamic image before photographing, and therefore, a user does not need to adjust the angle or position of the lens of the webcam. Furthermore, besides alphabet and numerical keys, a common keyboard has function keys to trigger specific functions of a computer, such as direct volume adjustment or software player control. However, the number of the alphanumeric keys is not small (one hundred and four keys for a standard keyboard), and the area they occupied is fixed. If more function keys are added to the keyboard, the keyboard would increase in its size and occupy more area. Although the size of the keyboard can be reduced by reducing the size of the function keys, the readability of the function keys would be reduced, which disturbs the operation of the user.

### BRIEF SUMMARY OF THE INVENTION

The invention relates to a computer system and a multimedia input device thereof. The multimedia input device has a plurality of hot keys for directly starting different functions of the computer system, and it allows users to clearly recognize the positions of the hot keys to operate the input device more conveniently and intuitively.

The invention provides a multimedia input device for providing a shortcut input of a computer system. The computer system has a computer host, a display device and a keyboard and may execute a plurality of programs. The multimedia input device includes a body and a plurality of hot keys. The body is connected to the computer host via wire or wireless. The hot keys are disposed on the body, and each of the hot keys corresponds to a predict program thus to directly start the programs of the computer system.

The invention further provides a computer system including a computer host, a display screen, a keyboard and a multimedia input device. The computer host may execute a plurality of programs. The display device displays the image of executing the program. The keyboard is connected to the computer host. The multimedia input device includes a body and a plurality of hot keys. The body is connected to the computer host via wire or wireless. The hot keys are disposed on the body, and each of them corresponds to a predict program to be executed.

These and other features, aspects, and advantages of the present invention will become better understood with regard to the following description, appended claims, and accompanying drawings.

### BRIEF DESCRIPTION OF THE DRAWINGS

FIG. 1A is a schematic diagram showing a computer system and an input device according to a preferred embodiment of the invention;

FIG. 1 B is a block diagram showing the computer system shown in FIG. 1A;

FIG. 2 is a block diagram showing a multimedia input device connected to a keyboard; and

FIG. 3 is a schematic diagram showing the multimedia input device shown in FIG. 1A.

### DETAILED DESCRIPTION OF THE EMBODIMENTS

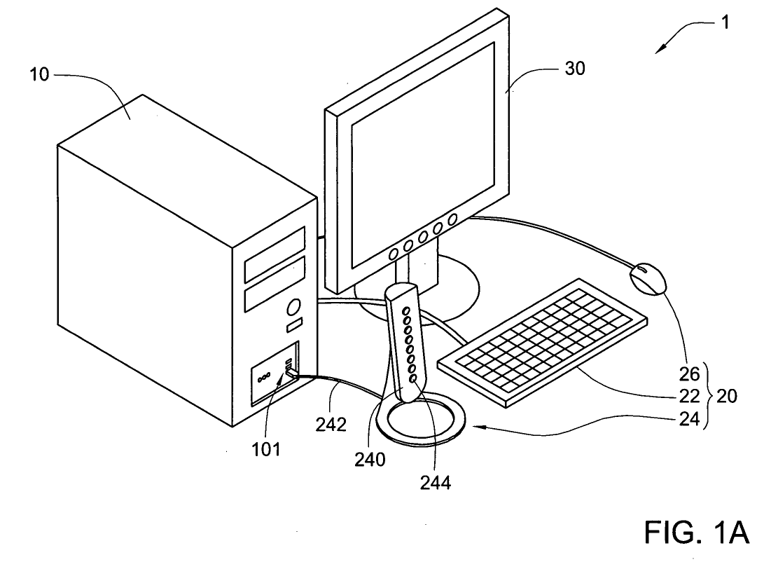

FIG. 1A is a schematic diagram showing a computer system and an input device thereof according to a preferred embodiment of the invention, and FIG. 1B is a block diagram showing the computer system shown in FIG. 1A. As shown in FIG. 1A and FIG. 1B, the computer system 1 includes a computer host 10 and an input device 20. The input device 20 includes a keyboard 22 and a multimedia input device 24. The keyboard 22 is connected to the computer host 10. The multimedia input device 24 includes a body 240 and a plurality of hot keys 244. The body 240 is movably adjacent to the keyboard 22, and it is connected to the computer host 10 via wire or wireless. The hot keys 244 are disposed on the body 240 and used for directly starting a plurality of programs of the computer system 1. In addition, the input device 20 further includes a mouse 26, and the computer system 1 further includes a display device 30 for displaying images.

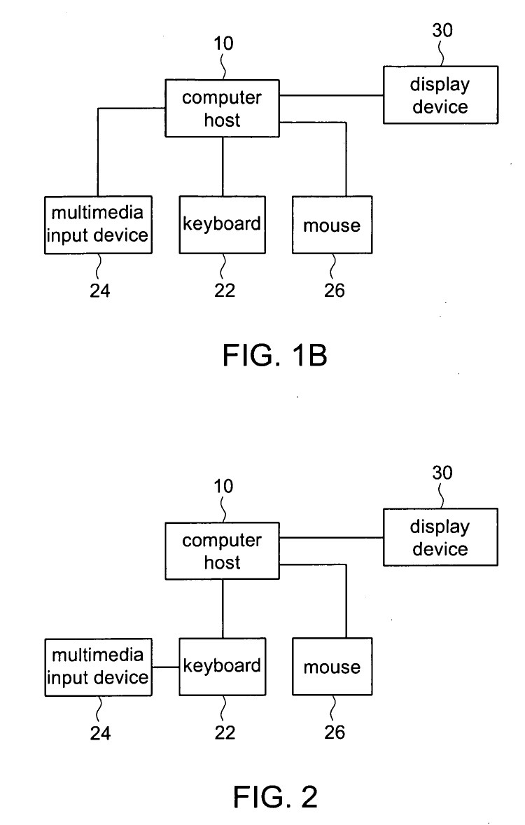

As shown in FIG. 1A, the body 240 of the embodiment is connected to the computer host 10 via a connector such as a connecting wire 242. However, in other embodiments, the connecting wire 242 also may connect the body 240 to the keyboard 22. As shown in FIG. 2, the multimedia input device 24 is connected to the keyboard 22 first and is connected to the computer host 10 indirectly via the keyboard 22.

As shown in FIG. 1A, the keyboard 22 of the embodiment is connected to the computer host 10 via wire. However, in other embodiments, the keyboard 22 also may be connected to the computer host 10 via wireless. As for the connecting wire 242 of the multimedia input device 24, it may be insertedly connected to a universal serial bus (USB) connecting port 101 of a computer host 10. If a USB hub is installed in the computer system 1, the connecting wire 242 also may be insertedly connected to the USB hub.

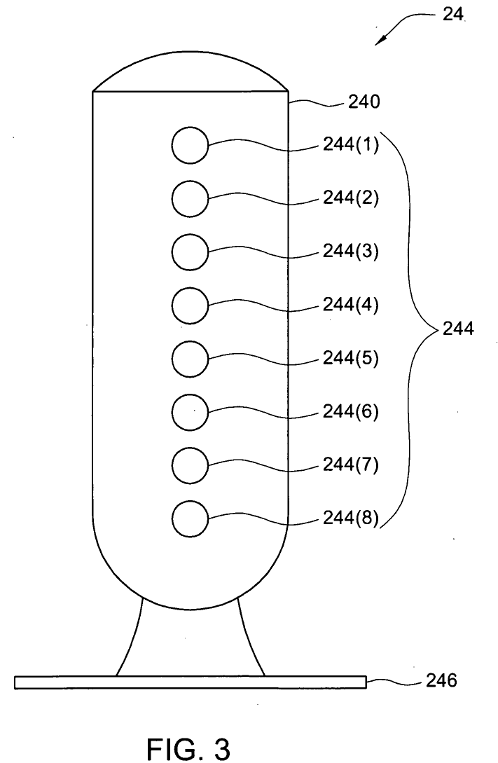

FIG. 3 is a schematic diagram showing the multimedia input device shown in FIG. 1A. As shown in FIG.3, the multimedia input device 24 further includes a base 246, and the body 240 is vertically disposed on the base 246 to allow one surface installed with the hot keys 244 on the body 240 to face a user. Thus, the user may directly know the position of the hot keys 244, and the multimedia input device 24 designed to be vertical occupies a less desk top area. The functions of the hot keys 244 are described hereinbelow.

The hot keys 244 include a time displaying key 244(1) for making the computer system 1 execute a time displaying program and making the display device 30 (shown in FIG. 1 A) display an instant time. After a user presses the time displaying key 244(1), a time window is popped up into the image of the display device 30. The time window has the time, data and time zone at that time. Thus, the user may know or adjust the time, data or time zone, and he also may inquire the time, data and time zone before and after.

The hot keys 244 also include a mail hot key 244(2) for starting a mail management program. When a user presses the mail hot key 244(2), the mail management program is started correspondingly, and the display device 30 displays the mail window of the mail management program. When the mail management program is started in advance, and the mail window is minimized, if the user presses the mail hot key 244(2), the mail window appears in the image of the display device 30 again.

The hot keys 244 further include a desktop displaying key 244(3) for making the display device 30 display a computer desktop. A user usually would build a different personalized shortcut management on the computer desktop according to the operation custom. After the user presses the desktop displaying key 244(3), the image of the display device 30 at that time is switched to the computer desktop to allow a user to directly choose the shortcut setting on the computer desktop.

In addition, the hot keys 244 also include a network hot key 244(4) and a favorite hot key 244(5). The network hot key 244(4) is used for starting a webpage browser program, and the favorite hot key 244(5) is used for starting the webpage browser program and making the display device 30 display a my favorite window. After a user presses the network hot key 244(4), a webpage is started directly, and the content thereof is displayed in the display device 30. If the user presses the favorite hot key 244(5) when the webpage is started, the my favorite window is popped up from one side of the webpage to allow the user to choose the stored webpage routes.

The hot keys 244 further include a search key 244(6) for starting the webpage browser program and making the display device 30 display a search window. When a user wants to search a file, he may directly press the search key 244(6) to make the search window displayed in the image of the display device 30. Then, the user may input partial or all information of the file which he wants to search to make the computer host 10 execute search steps according to the information.

In addition, the hot keys 244 further include a play key 244(7) and a volume adjusting key 244(8) to meet an audio and video playing function of the computer system 1. The play key 244(7) is used for making a multimedia playing program of the computer system 1 start or pause, and the volume adjusting key 244(8) is used to increase or decrease the volume.

In other embodiment, a pausing key also may be added to the hot keys 244 to replace the pausing function of the play key 244(7). As for the volume adjusting key 244(8), it may be replaced with an independent volume increasing key and an independent volume decreasing key. Furthermore, a mute key may be added to the hot keys 244 to stop outputting any voice.

Although the time displaying key 244(1), the mail hot key 244(2), the desktop displaying key 244(3), the network hot key 244(4), the favorite hot key 244(5), the search key 244(6), the play key 244(7) and the volume adjusting key 244(8) are arranged at the body 240 from the top to bottom in turn, as shown in FIG. 3, it is just used for describing instead of limiting the invention. The hot keys also may be disposed at the body 240 in other form or sequence.

Different patterns or words may be marked beside each of the hot keys 244 to allow users to know the functions of the hot keys 244 easily, which improves the readability of the hot keys 244. For example, an “envelope” pattern may be marked beside the mail hot key 244(2), a “www” word may be marked beside the network hot key 244(4), and a “loudspeaker” pattern may be marked beside the volume adjusting key 244(8). In addition, since the multimedia input device 24 is independent of the keyboard 22 or the mouse 26, the area of the hot keys 244 on the vertical surface of the body 240 may be enlarged appropriately. Thus, the readability of the hot keys 244 increases.

Preferably, the multimedia input device 24 further includes a microphone which may be disposed in the body 240, and the microphone faces a user (or other voice sources) to capture the voice of the user clearly. In addition, the multimedia input device 24 also may include a camera disposed in the body 240, and the lens of the camera faces a user to capture the image of the user or allow the user to move articles to the position in front of the lens readily.

The operation is facilitated via the hot keys 244 on the multimedia input device 24. Taking the disposal manner of the input device 20 in FIG. 1B as example, when a user is used to operating the mouse 26 by the right hand, and he puts the mouse 26 on the right side of the keyboard 22, preferably, the multimedia input device 24 may be disposed at the left side of the keyboard 22. In this way, if a user wants to start a function such as starting the mail window or adjusting the volume in the computer system 1 when he operates the mouse 26 by the right hand, he does not need to move the mouse 26 executing the present works away, and he may directly to press the hot key 244 on the multimedia input device 24 by the left hand. Thus, the user may start the functions of the computer system 1 directly and rapidly. The multimedia input device 24 also may be moved to any position to facilitate the operation according to the personal custom of a user.

In the computer system and the multimedia input device thereof disclosed by the embodiment, various hot keys are integrated in a body which may be moved randomly. The vertical multimedia input device may save the occupied area on the desk top and allow a user to press the hot keys on the body intuitively, which increases the practicability and intimacy of the multimedia input device. In addition, the multimedia input device is independent of the keyboard or the mouse, and therefore, the hot keys on the vertical surface of the multimedia input device may be enlarged appropriately to increase the readability of the hot keys.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A multimedia input device adapted to a computer system having a display device, a computer host and a keyboard for executing a plurality of programs, the multimedia input device comprising:
a body connected to the computer host via wire or wireless; and
a plurality of hot keys disposed at the body, and each of the hot keys corresponds to a predict program to be executed.

2. The multimedia input device according to claim 1, wherein the multimedia input device further comprises a connector for connecting the body and the computer host, and the connector is insertedly connected to a universal serial bus (USB) connecting port or a USB hub of the computer host.

3. The multimedia input device according to claim 1, wherein the multimedia input device further comprises a connector for connecting the body and the keyboard, and the body is connected to the computer host via the connector and the keyboard.

4. The multimedia input device according to claim 1, wherein the hot keys comprise a mail hot key for starting a mail management program.

5. The multimedia input device according to claim 1, wherein the hot keys comprise a network hot key for starting a webpage browser program.

6. The multimedia input device according to claim 1, wherein the hot keys comprise a play key for making a multimedia playing program of the computer system start or pause.

7. The multimedia input device according to claim 1, wherein the hot keys comprise a volume adjusting key for increasing or decreasing the volume.

8. The multimedia input device according to claim 1, wherein the hot keys comprise a search key for starting a webpage browser program and making the display device display a search window.

9. The multimedia input device according to claim 1, wherein the hot keys comprise a favorite hot key for starting a webpage browser program and making the display device display a my favorite window.

10. The multimedia input device according to claim 1, wherein the hot keys comprise a desktop displaying key for making the display device display a computer desktop.

11. The multimedia input device according to claim 1, wherein the hot keys comprise a time displaying key for making the computer system execute a time displaying program to make the display device display an instant time.

12. The multimedia input device according to claim 1, wherein the body has at least one of a microphone and a camera.

13. A computer system comprising:
a computer host for executing a plurality of programs;
a display device displaying images of executing the programs;
a keyboard connected to the computer host; and
a multimedia input device including:
a body connected to the computer host via wire or wireless; and
a plurality of hot keys disposed on the body, and each of the hot keys corresponds to a predict program to be executed.

14. The computer system according to claim 13, wherein the multimedia input device further comprises a connector for connecting the body and the computer host, and the connector is insertedly connected to a USB connecting port or a USB hub of the computer host.

15. The computer system according to claim 13, wherein the multimedia input device further comprises a connector for connecting the body and the keyboard, and the body is connected to the computer host via the connector and the keyboard.

16. The computer system according to claim 13, wherein the hot keys comprise a mail hot key for starting a mail management program.

17. The computer system according to claim 13, wherein the hot keys comprise a network hot key for starting a webpage browser program.

18. The computer system according to claim 13, wherein the hot keys comprise a play key for making a multimedia playing program of the computer system start or pause.

19. The computer system according to claim 13, wherein the hot keys comprise a volume adjusting key for increasing or decreasing the volume.

20. The computer system according to claim 13, wherein the hot keys comprise a search key for starting a webpage browser program and making the display device display a search window.

21. The computer system according to claim 13, wherein the hot keys comprise a favorite hot key for starting a webpage browser program and making the display device display a my favorite window.

22. The computer system according to claim 13, wherein the hot keys comprise a desktop displaying key for making the display device display a computer desktop.

23. The computer system according to claim 13, wherein the hot keys comprise a time displaying key for making the computer system execute a time displaying program to make the display device display an instant time.

24. The computer system according to claim 13, wherein the body has at least one of a microphone and a camera.
